(19) United States
(12) Patent Application Publication
(10) Pub. No.: US 2024/0303465 A1
(43) Pub. Date: Sep. 12, 2024

(54) METHOD FOR TRAINING RANKING MODEL FOR INTELLIGENT RECOMMENDATION, AND INTELLIGENT RECOMMENDATION METHOD

(71) Applicant: BEIJING BAIDU NETCOM SCIENCE TECHNOLOGY CO., LTD., Beijing (CN)

(72) Inventors: Xuechao WU, Beijing (CN); Qian CAO, Beijing (CN); Xiahui HE, Beijing (CN); Yunlong BAI, Beijing (CN)

(73) Assignee: BEIJING BAIDU NETCOM SCIENCE TECHNOLOGY CO., LTD., Beijing (CN)

(21) Appl. No.: 18/020,910

(22) PCT Filed: Jun. 1, 2022
(86) PCT No.: PCT/CN2022/096599

§ 371 Date: Feb. 10, 2023

(30) Foreign Application Priority Data
Nov. 19, 2021 (CN) 202111402589.4

(51) Int. Cl. G06N 3/042

(52) U.S. Cl. CPC G06N 3/042

(57) ABSTRACT

A method for training a ranking model for intelligent recommendation, and an intelligent recommendation method are provided, which relate to fields of data processing and machine learning technologies. The method includes: acquiring first user data and first resource data of a target domain, and acquiring second user data and second resource data of a source domain; determining an implicit feature based on the first user data, the first resource data, the second user data and the second resource data; and training the ranking model based on the implicit feature, wherein the ranking model is configured to recommend a resource to a user of the target domain.

This application claims priority to Chinese Application No. 202111402589.4, filed to China National Intellectual Property Administration on Nov. 19, 2021 and entitled “METHOD AND APPARATUS FOR TRAINING RANKING MODEL FOR INTELLIGENT RECOMMENDATION, INTELLIGENT RECOMMENDATION METHOD AND APPARATUS”, the content of which is incorporated by reference in its entirety.

### TECHNICAL FIELD

The present disclosure relates to a field of computer technology, and in particular, to fields of data processing and machine learning technologies.

### BACKGROUND

Cross-domain recommendation refers to a recommendation system using relatively rich information from richer domains, so as to improve a recommendation performance in sparser domains. In the related art, a problem of sparse samples in a target domain is solved by adding samples from a source domain to a training of the target domain. However, due to the inconsistency in a sample distribution of the source domain and the target domain, it will lead to a phenomenon of “negative transfer”, which will affect the recommendation effect of the model in the recommendation process.

### SUMMARY

The present disclosure provides a method and an apparatus for training a ranking model for intelligent recommendation, an intelligent recommendation method and an intelligent recommendation apparatus.

According to one aspect of the present disclosure, a method for training a ranking model is provided, including:
acquiring first user data and first resource data of a target domain, and acquiring second user data and second resource data of a source domain;
determining an implicit feature based on the first user data, the first resource data, the second user data and the second resource data; and
training the ranking model based on the implicit feature, wherein the ranking model is configured to recommend a resource to a user of the target domain.

According to another aspect of the present disclosure, an intelligent recommendation method is provided, including:
acquiring user data of one or more users to be recommended and resource data of one or more resources to be recommended of the target domain;
obtaining an implicit feature based on the user data and the resource data; and
inputting the implicit feature into the ranking model, and determining the resource to be recommended matched with the user to be recommended from the resource data according to a ranking result of the ranking model,
wherein the ranking model is obtained by training according to the method for training a ranking model of any one of the embodiments of the present disclosure.

According to another aspect of the present disclosure, an apparatus for training a ranking model is provided, including:
a data acquiring module configured to acquire first user data and first resource data of a target domain, and acquiring second user data and second resource data of a source domain;
a feature determining module configured to determine an implicit feature based on the first user data, the first resource data, the second user data and the second resource data; and
a first training module configured to train the ranking model based on the implicit feature, wherein the ranking model is configured to recommend a resource to a user of the target domain.

According to another aspect of the present disclosure, an intelligent recommendation apparatus is provided, including:
a first acquiring module configured to acquire user data of one or more users to be recommended and resource data of one or more resources to be recommended of a target domain;
a second acquiring module configured to obtain an implicit feature based on the user data and the resource data; and
a resource determining module configured to input the implicit feature into a ranking model, and determine the resource to be recommended matched with the user to be recommended from the resource data according to a ranking result of the ranking model,
wherein the ranking model is obtained by training according to the method for training a ranking model of any one of the embodiments of the present disclosure.

According to another aspect of the present disclosure, an electronic device is provided, including: at least one processor; and a memory communicatively connected with the at least one processor; wherein the memory stores instructions executable by the at least one processor, and the instructions, when executed by the at least one processor, cause the at least one processor to perform the method of any one of the embodiments of the present disclosure.

According to another aspect of the present disclosure, a non-transitory computer-readable storage medium storing computer instructions is provided, wherein the computer instructions are configured to cause the computer to perform the method of any one of the embodiments of the present disclosure.

According to another aspect of the present disclosure, a computer program product including a computer program is provided, wherein the computer program, when executed by a processor, implements the method of any one of the embodiments of the present disclosure.

In the method and the apparatus for training a ranking model, the intelligent recommendation method and the intelligent recommendation apparatus provided by the embodiments of the present disclosure, the data of the source domain is introduced into the training data of the ranking model in a form of implicit feature, so as to avoid a phenomenon of “negative transfer” caused by directly using the data of the source domain as a training sample, which may improve the recommendation effect of the ranking model applied to resource recommendation.

It should be understood that the content described in this section is not intended to identify key or important features of the embodiments of the present disclosure, nor is it intended to limit the scope of the present disclosure. Other features of the present disclosure will be easily understood through the following description.

### BRIEF DESCRIPTION OF THE DRAWINGS

The drawings are used to better understand the present solution, and do not constitute a limitation to the present disclosure, in which:

FIG. 1 is a flowchart of a method for training a ranking model in an embodiment of the present disclosure;

FIG. 2 is a flowchart of a method for training a ranking model in an embodiment of the present disclosure;

FIG. 3 is a flowchart of an intelligent recommendation method in an embodiment of the present disclosure;

FIG. 4 is a schematic diagram of an apparatus for training a ranking model in an embodiment of the present disclosure;

FIG. 5 is a schematic diagram of a feature determining module in an embodiment of the present disclosure;

FIG. 6 is a schematic diagram of an intelligent recommendation apparatus in an embodiment of the present disclosure;

FIG. 7 is a block diagram of an electronic device for implementing a method for training a ranking model or an intelligent recommendation method of the embodiments of the present disclosure.

### DETAILED DESCRIPTION OF EMBODIMENTS

The following describes exemplary embodiments of the present disclosure with reference to the drawings, which include various details of the embodiments of the present disclosure to facilitate understanding, and should be regarded as merely exemplary. Therefore, those skilled in the art should recognize that various changes and modifications may be made to the embodiments described herein without departing from the scope and spirit of the present disclosure. Likewise, for clarity and conciseness, descriptions of well-known functions and structures are omitted in the following description.

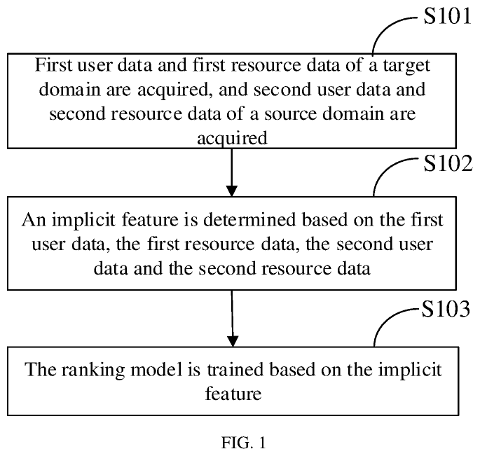

The embodiments of the present disclosure provide a method for training a ranking model for intelligent recommendation. FIG. 1 is a flowchart of a method for training a ranking model according to an embodiment of the present disclosure. The method may be applied to an apparatus for training a ranking model. For example, when the apparatus is deployed on a terminal or a server or other processing equipment for execution, the apparatus may perform ranking model training and the like. The terminal may be user equipment (UE), mobile device, cellular phone, cordless phone, personal digital assistant (PDA), handheld device, computing device, vehicle-mounted device, wearable device, and the like. In some possible implementation manners, the method may also be implemented in a manner in which the processor invokes computer-readable instructions stored in the memory.

As shown in FIG. 1, the method includes the following steps. In step S101, first user data and first resource data of a target domain are acquired, and second user data and second resource data of a source domain are acquired.

The target domain and the source domain may be any service scenario or service product, and the number of the source domain and the target domain may be one or more, which is not limited in this disclosure. Compared to the source domain, the target domain is a domain to which the trained ranking model is to be applied.

The terminal or the server may respectively obtain the data of the target domain and the data of the source domain from a pre-established target domain database and source domain database. The first user data and the second user data may include, but are not limited to, basic data of the user (for example, user identification, age, gender, etc.), behavior sequence data of the user (user behavior records, for example, the user browse a certain category of articles continuously for a period of time), request data of the user (IP address from which the request is transmitted, information of the terminal transmitting the request, etc.). The first resource data and the second resource data include, but are not limited to, a resource identifier, a resource category (for example, a title and a category of an article, etc.), and data related to the service scenario (for example, education and life-related service scenarios, etc.).

In step S102, an implicit feature is determined based on the first user data, the first resource data, the second user data and the second resource data.

The implicit feature is jointly determined according to the user data and resource data of the target domain and the user data and resource data of the source domain. The implicit feature may be a feature vector without specific physical meaning.

In step 103, the ranking model is trained based on the implicit feature.

A training sample set of the ranking model is constructed according to the implicit feature obtained from the data of the target domain and the data of the source domain, so as to train the ranking model. The ranking model is used to recommend a resource to a user of the target domain.

In the method for training a ranking model provided by the embodiments of the present disclosure, the data of the source domain is introduced into the training data of the ranking model in a form of implicit feature, so as to avoid a phenomenon of “negative transfer” caused by directly using the data of the source domain as a training sample, which may improve the recommendation effect of the ranking model applied to resource recommendation.

In a possible implementation, the method for training a ranking model further includes:
determining an explicit feature based on the first user data and the first resource data; and
training the ranking model based on the explicit feature and the implicit feature.

In practical applications, a user feature and a resource feature may be extracted from the first user data and the first resource data of the target domain through data statistics, etc., as the explicit feature of the target domain. The explicit feature may be a feature having a specific physical meaning, such as a number used to represent the user's age, etc. By using the explicit feature obtained from the data of the target domain and the implicit feature obtained from the data of the target domain and the data of the source domain, a training sample set of the ranking model is constructed and the ranking model is trained. The ranking model is used to recommend a resource to a user of the target domain.

In the embodiments of the present disclosure, the ranking model is trained based on the explicit feature and the implicit feature, which enriches the feature information of training samples and may improve the recommendation effect of the ranking model applied to resource recommendation.

In the technical solution of the present disclosure, when there are a plurality of target domains, how to determine the explicit feature may be specifically showed to in the following embodiments.

In a possible implementation, the determining an explicit feature based on the first user data and the first resource data includes:
acquiring a first explicit user feature from the first user data of each of a plurality of target domains using a same feature encoding manner, and acquiring a first explicit resource feature from the first resource data of each of the plurality of target domains using a same feature encoding manner, formats of the first explicit user features of the plurality of target domains are identical to each other, and formats of the first explicit resource features of the plurality of target domains are identical to each other; and
concatenating, for each of the plurality of target domains, the first explicit user feature and the first explicit resource feature in a first concatenating manner, to obtain the explicit feature.

In practical applications, if there are a plurality of target domains, that is, the trained ranking model is for common use by the plurality of target domains, the same feature extraction logic is configured for the plurality of target domains, and the same encoding manner is used to the extracted feature is to obtain a unified feature format, so that the features of different target domains are mapped to similar feature spaces, and data distributions of the plurality of target domains are close. For example, an age feature of user A extracted from the first target domain is 26, and an age feature of user B extracted from the second target domain is 30. Logics of extracting the two user features are the same, and then the two user features are encoded in the same encoding manner to obtain features in the same format. The explicit user feature is acquired from the user data of each target domain using the same feature encoding manner, and the explicit resource feature is acquired from the resource data of each target domain using the same feature encoding manner. For each target domain, the explicit user feature and the explicit resource feature are concatenated in the first concatenating manner to obtain the final explicit feature.

The first concatenating manner may be a horizontal concatenating of the explicit user feature and the explicit resource feature. For example, the explicit user feature is a 128-dimensional vector, and the explicit resource feature is a 100-dimensional vector. The explicit user feature vector and the explicit resource feature vector are concatenated horizontally to obtain an explicit feature vector of 128+100=228 dimensions.

In the embodiments of the present disclosure, the data of the plurality of target domains may be used to increase the number of samples and solve the problem of data sparseness of training samples in a single target domain. By using the same feature encoding manner to obtain the explicit user feature and the explicit resource feature of each target domain, the extracted explicit features may be mapped to a similar feature space with close data distribution and reduce the negative transfer phenomenon caused by joint training of data from different domains.

In a possible implementation, the determining an implicit feature based on the first user data, the first resource data, the second user data and the second resource data includes:
extracting a first implicit user feature from the first user data using a collaborative filtering manner, in a case of determining that the target domain and the source domain have an overlapping user according to the first user data and the second user data,
extracting a second implicit user feature from the second user data of the overlapping user using the collaborative filtering manner;
concatenating the first implicit user feature and the second implicit user feature in a second concatenating manner to obtain a concatenating user feature; and
determining the implicit feature based on the concatenating user feature.

The target domain and the source domain having an overlap may include that at least one of the user and the resource of the target domain and the source domain have an overlap, and it is determined whether there is an overlapping user between the target domain and the source domain according to the first user data and the second user data. The overlapping user may include a user who is both a user of the source domain and a user of the target domain, and has usage records in the corresponding products of the source domain and the target domain. For example, user A uses both the search application program B1 and the social application program B2, then user A is an overlapping user of the application program B1 and the application program B2.

If the source domain and the target domain have an overlapping user, the collaborative filtering manner is used to extract the first implicit user feature from the first user data, which may be an implicit UCF (User Collaborative Filtering) feature. The second implicit user feature is extracted from the second user data of the overlapping user using the same implicit feature extraction manner, and the second user data of the overlapping user may be user data of the overlapping user in the source domain. The first implicit user feature and the second implicit user feature are concatenated in the second concatenating manner. The second concatenating manner may include adding elements of a feature vector of the first implicit user feature and a feature vector of the second implicit user feature by adding elements at corresponding positions in the two feature vectors. For example, the first implicit user feature is a 128-dimensional vector, and the second implicit user feature is also a 128-dimensional vector, and the concatenated user feature obtained by concatenating the first implicit user feature and the second implicit user feature in the second concatenating manner is also a 128-dimensional vector.

The concatenating user feature may be used as the implicit feature or a part of the implicit feature. Optionally, the determining the implicit feature based on the concatenating user feature includes:
extracting a first implicit resource feature from the first resource data using a collaborative filtering manner,
extracting a first joint implicit feature from the first user data and the first resource data using a graph neural network,
extracting a second joint implicit feature using the graph neural network based on the first resource data and the second user data of the overlapping user; and
concatenating the first joint implicit feature and the second joint implicit feature in the second concatenating manner to obtain a first concatenating joint implicit feature; and
concatenating the first implicit resource feature, the first concatenating joint implicit feature, and the concatenating user feature in the first concatenating manner to obtain the implicit feature.

In the embodiments of the present disclosure, in a case of the source domain and the target domain having an overlapping user, the user data of the source domain is introduced into the training data of the ranking model in the form of implicit feature, so as to avoid the phenomenon of “negative transfer” caused by directly using the data of the source domain as training samples, enrich the feature information of training samples, which may improve the recommendation effect of ranking model applied to resource recommendations. Moreover, the method of extracting implicit feature by collaborative filtering is simple, and the computational complexity is lower than that of extracting implicit feature through deep learning model.

In a possible implementation, the concatenating the first implicit user feature and the second implicit user feature in a second concatenating manner to obtain a concatenating user feature includes:
determining a first weight corresponding to the second implicit user feature based on a number of the second user data of the overlapping user and a number of the first user data; and
obtaining the concatenating user feature based on the first implicit user feature, the second implicit user feature and the first weight.

In practical applications, when concatenating the first implicit user feature and the second implicit user feature, the weight of the implicit user feature of the introduced source domain data may be determined according to the data scale of the source domain and the target domain. The first implicit user feature and the second implicit user feature are weighted and calculated to obtain the concatenating user feature.

The number of the first user data may be a number of the samples of the user data obtained from the target domain. For example, if the user data corresponding to 100 users is acquired from the target domain, and the 100 users correspond to 200 user data, the number of the first user data is 200.

The number of the second user data of the overlapping user may be a number of the samples of the overlapping user in the source domain, that is, a scale of the samples introduced into the source domain. For example, the source domain and the target domain have 100 overlapping users, if the 100 overlapping users correspond to 100 user data in the source domain, the number of second user data of the overlapping users is 100. If the 100 overlapping users correspond to 300 user data in the source domain, the number of the second user data of the overlapping users is 300.

In the embodiments of the present disclosure, the weight of the implicit feature corresponding to the introduced source domain data is determined according to the sample size of the data of the source domain and the data of the target domain. The implicit vector of the source domain is introduced through weighted calculation, which enriches the feature information of the training samples.

In a possible implementation, the determining an implicit feature based on the first user data, the first resource data, the second user data and the second resource data includes:
extracting a first implicit resource feature from the first resource data using a collaborative filtering manner, in a case of determining that the target domain and the source domain have an overlapping resource according to the first resource data and the second resource data,
extracting a second implicit resource feature from the second resource data of the overlapping resource using the collaborative filtering manner;
concatenating the first implicit resource feature and the second implicit resource feature in a second concatenating manner to obtain a concatenating resource feature; and determining the implicit feature based on the concatenating resource feature.

In practical applications, it is determined whether the target domain and the source domain have an overlapping resource according to the first resource data and the second resource data, and the overlapping resource may include a resource which is both a resource of the source domain and a resource of the target domain. For example, article C is both a resource in search application B1 and a resource in social application B2, then article C is an overlapping resource of application B1 and application B2.

If the source domain and the target domain have an overlapping resource, the collaborative filtering manner is used to extract the first implicit resource feature from the first resource data, which may be an implicit ICF (Item Collaborative Filtering) feature. The second implicit resource feature is extracted from the second resource data of the overlapping resource using the same implicit feature extraction manner. The second resource data of the overlapping resource may be the resource data of the overlapping resource in the source domain. The first implicit resource feature and the second implicit resource feature are concatenated in the second concatenating manner. The second concatenating manner may include adding elements of a feature vector of the first implicit resource feature and a feature vector of the second implicit resource feature by adding elements at corresponding positions in the two feature vectors. For example, the first implicit resource feature is a 128-dimensional vector, and the second implicit resource feature is also a 128-dimensional vector, then the concatenating resource obtained by concatenating the first implicit resource feature and the second implicit resource feature in the second concatenating manner is also a 128-dimensional vector.

The concatenating resource feature may be used as the implicit feature or a part of the implicit feature. Optionally, the determining the implicit feature based on the concatenating resource feature includes:
extracting a first implicit user feature from the first user data using a collaborative filtering manner,
extracting a first joint implicit feature from the first user data and the first resource data using a graph neural network,
extracting a third joint implicit feature using the graph neural network based on the first user data and the second resource data of the overlapping resource; and
concatenating the first joint implicit feature and the third joint implicit feature in the second concatenating manner to obtain a second concatenating joint implicit feature; and
concatenating the first implicit user feature, the first concatenating joint implicit feature, and the concatenating resource feature in the first concatenating manner to obtain the implicit feature.

In the embodiments of the present disclosure, in a case of the source domain and the target domain having an overlapping resource, the resource data of the source domain is introduced into the training data of the ranking model in the form of implicit feature, so as to avoid the phenomenon of “negative transfer” caused by directly using the data of the source domain as training samples, enrich the feature information of training samples, which may improve the recommendation effect of ranking model applied to resource recommendations. Moreover, the method of extracting implicit feature by collaborative filtering is simple, and the computational complexity is lower than that of extracting implicit feature through deep learning model.

In a possible implementation, the concatenating the first implicit resource feature and the second implicit resource feature in a second concatenating manner to obtain a concatenating resource feature includes:
determining a second weight corresponding to the second implicit resource feature based on a number of the second resource data of the overlapping resource and a number of the first resource data; and
obtaining the concatenating resource feature based on the first implicit resource feature, the second implicit resource feature and the second weight.

In practical applications, when concatenating the first implicit resource feature and the second implicit resource feature, the weight of the implicit resource feature of the introduced source domain data may be determined according to the data scale of the source domain and the target domain. The first implicit resource feature and the second implicit resource feature are weighted and calculated to obtain the concatenating resource feature.

The number of the first resource data may be a number of the samples of the resource data obtained from the target domain. For example, if the resource data corresponding to 100 resources is acquired from the target domain, and the 100 resources correspond to 200 resource data, the number of the first resource data is 200.

The number of the second resource data of the overlapping resource may be a number of the samples of the overlapping resource in the source domain, that is, a scale of the samples introduced into the source domain. For example, the source domain and the target domain have 100 overlapping resources, if the 100 overlapping resources correspond to 100 resource data in the source domain, the number of second resource data of the overlapping resources is 100. If the 100 overlapping resources correspond to 300 resource data in the source domain, the number of the second resource data of the overlapping resources is 300.

In the embodiments of the present disclosure, the weight of the implicit feature corresponding to the introduced source domain data is determined according to the sample size of the data of the source domain and the data of the target domain. The implicit vector of the source domain is introduced through weighted calculation, which enriches the feature information of the training samples.

In a possible implementation, the determining an implicit feature based on the first user data, the first resource data, the second user data and the second resource data includes:
extracting a first joint implicit feature from the first user data and the first resource data using a graph neural network, in a case of determining that the target domain and the source domain have an overlapping user according to the first user data and the second user data,
extracting a second joint implicit feature using the graph neural network based on the first resource data and second user data of the overlapping user; and
determining the implicit feature based on the first joint implicit feature and the second joint implicit feature.

In practical applications, in a case of the target domain and the source domain having an overlapping user, a graph neural network (GNN) may be used to extract the first joint implicit feature from the first user data and the first resource data, which may be implicit GCF (Graph Collaborative Filtering) feature. The second joint implicit resource feature is extracted from the first resource data and the second user data of the overlapping user using the same implicit feature extraction manner. The first joint implicit feature and the second joint implicit feature are concatenated in the second concatenating manner to obtain the concatenating joint implicit feature as the implicit feature. Alternatively, the concatenating joint implicit feature is used as a part of the implicit feature, and then concatenated with the implicit user feature and concatenating resource feature in the first concatenating manner to obtain the implicit feature.

In the embodiments of the present disclosure, the implicit feature is extracted through the graph neural network, and the feature extraction accuracy is high, and the effect is good.

Optionally, in a case of the target domain and the source domain having both an overlapping user and an overlapping resource, the second user data of the overlapping user and the second resource data of the overlapping resource may be used to extract the joint implicit feature through GNN. The final implicit feature is determined based on the joint implicit feature.

In a possible implementation, the determining an implicit feature based on the first user data, the first resource data, the second user data and the second resource data includes:
extracting a first joint implicit feature from the first user data and the first resource data using a graph neural network, in a case of determining that the target domain and the source domain have an overlapping resource according to the first resource data and the second resource data,
extracting a third joint implicit feature using the graph neural network based on the first user data and second resource data of the overlapping resource; and
determining the implicit feature based on the first joint implicit feature and the third joint implicit feature.

In practical applications, in a case of the target domain and the source domain having an overlapping resource, the GNN may be used to extract the first joint implicit feature from the first user data and the first resource data, which may be implicit GCF (Graph Collaborative Filtering) feature. The third joint implicit resource feature is extracted from the first user data and the second resource data of the overlapping resource using the same implicit feature extraction manner. The first joint implicit feature and the third joint implicit feature are concatenated in the second concatenating manner to obtain the concatenating joint implicit feature as the implicit feature. Alternatively, the concatenating joint implicit feature is used as a part of the implicit feature, and then concatenated with the implicit resource feature and concatenating user feature in the first concatenating manner to obtain the implicit feature.

In the embodiments of the present disclosure, the implicit feature is extracted through the graph neural network, and the feature extraction accuracy is high and the effect is good.

In a possible implementation, the method further includes:
determining the implicit feature based on the first user data and the first resource data, in a case of determining that the target domain and the source domain have no overlapping user according to the first user data and the second user data and that the target domain and the source domain have no overlapping resource according to the first resource data and the second resource data.

In practical applications, in a case of the target domain and the source domain having neither overlapping user nor overlapping resource, the explicit feature is extracted from the first user data and the first resource data, and the first implicit user feature and the first implicit resource feature are extracted from the first user data and the first resource data respectively by means of collaborative filtering. A joint implicit feature is extracted from the first user data and the first resource data through GNN. The first implicit user feature, the first implicit resource feature and the joint implicit feature are concatenated to obtain the implicit feature. A training sample of the model is obtained by concatenating the explicit feature and the implicit feature.

In the embodiments of the present disclosure, in a case of the target domain and the source domain having neither overlapping user nor overlapping resource, the user data and resource data of the target domain are used to determine the implicit feature, and the training sample is constructed based on the explicit feature and the implicit feature. The ranking model trained in this way has a higher prediction accuracy in resource recommendation.

In one example, the implicit vector may be calculated by the following equations (1) and (2):

$${V}_{xCF} = \{ \begin{matrix}{v}_{xCF} , & No user / resource overlap \\ {v}_{xCF} + {γ}_{i} \times {v}_{{xCF}^{′}} , & user / resource overlap\end{matrix} \qquad ( 1 )$$

$${γ}_{i} = \frac{{N}_{i}}{M} \qquad ( 2 )$$

xCF represents UCF, ICF, GCF vectors, V_{xCF} represents the implicit feature, V_{xCF} represents the implicit feature of the data in the target domain, V_{xCF′} represents the implicit feature of the data in the source domain, γᵢ represents the weight of the implicit feature of the source domain introduced by the i-th target domain. When there are a plurality of target domains, Ni represents a sample size of the i-th target domain, and M represents the sample size of the source domain.

In a possible implementation, the training the ranking model based on the explicit feature and the implicit feature includes:
concatenating the explicit feature and the implicit feature in a first concatenating manner to obtain a first concatenating feature, and acquiring a sample label corresponding to the first concatenating feature;
training the ranking model based on the first concatenating feature and the corresponding sample label.

In practical applications, the first concatenating feature obtained by concatenating the explicit feature and the implicit feature in the first concatenating manner may be used as a training sample. In this way, a plurality of training samples are obtained based on a plurality of user data and a plurality of resource data. For each training sample, the sample label is configured according to the specific application scenario of the ranking model. For example, the sample label may be: whether the user clicks, the duration of the user browsing, whether the user consumes, etc. The ranking model is trained using the training sample set composed of the training samples and the sample labels.

In the embodiments of the present disclosure, the explicit feature is determined according to the data of the target domain, in a case of the source domain and the target domain having an overlap, the data of the source domain is introduced into the training data of the ranking model in the form of implicit feature, so as to avoid the phenomenon of “negative transfer” caused by directly using the data of the source domain as training samples. The ranking model is trained based on the explicit feature and the implicit feature, which enriches the feature information of training samples, and may improve the recommendation effect of ranking model applied to resource recommendations.

In a possible implementation, the method further includes:
acquiring user data of one or more users to be recommended and resource data of one or more resources to be recommended of the target domain;
obtaining an implicit feature based on the user data and the resource data;
inputting the implicit feature into the ranking model, and determining the resource to be recommended matched with the user to be recommended from the resource data according to a ranking result of the ranking model.

In practical applications, the ranking model may be used in resource recommendation, and the implicit user feature and the implicit resource feature corresponding to user data and resource data are extracted respectively through collaborative filtering and GNN and are concatenated in first concatenate manner to obtain the implicit feature. The implicit feature is input into the ranking model, and the resource to be recommended matched with the user to be recommended is determined from the resource data according to the ranking result of the ranking model.

In the embodiments of the present disclosure, resource recommendation is performed on the user to be recommended according to the ranking result of the ranking model. The ranking model is obtained by training based on the implicit feature of the target domain data and the source domain data. Using the ranking model for resource recommendation may improve the recommendation effect.

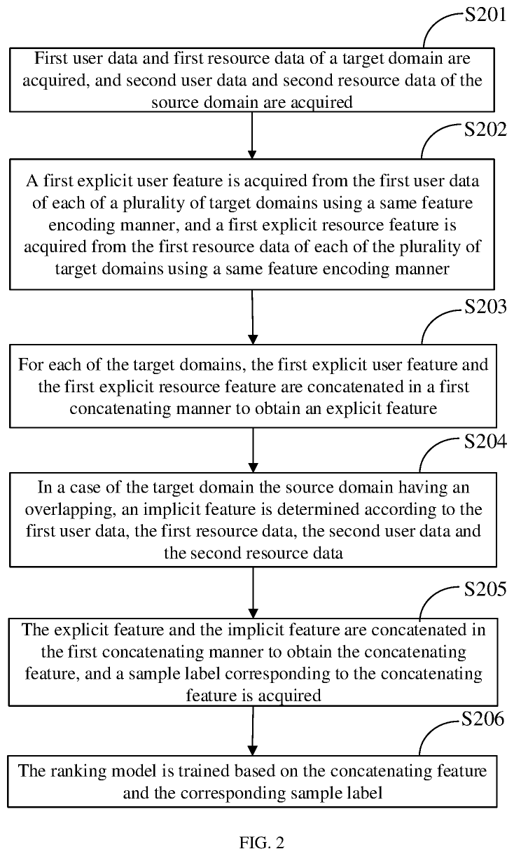

FIG. 2 is a flowchart of a method for training a ranking model in an embodiment of the present disclosure. As shown in FIG. 2, the method includes the following steps.

In step S201, first user data and first resource data of a target domain are acquired, and second user data and second resource data of the source domain are acquired.

In step S202, a first explicit user feature is acquired from the first user data of each of a plurality of target domains using a same feature extraction manner, and a first explicit resource feature is acquired from the first resource data of each of the plurality of target domains using a same feature extraction manner.

In step S203, for each of the target domains, the first explicit user feature and the first explicit resource feature are concatenated in a first concatenating manner to obtain an explicit feature.

In step S204, in a case of the target domain the source domain having an overlap, an implicit feature is determined according to the first user data, the first resource data, the second user data and the second resource data.

In step S205, the explicit feature and the implicit feature are concatenated in the first concatenating manner to obtain the concatenating feature, and a sample label corresponding to the concatenating feature is acquired.

In step S206, the ranking model is trained based on the concatenating feature and the corresponding sample label.

In the embodiments of the present disclosure, the data of the plurality of target domains may be used to increase the number of samples and solve the problem of data sparseness of training samples in a single target domain. By using the same feature encoding manner to obtain the explicit user feature and the explicit resource feature of each target domain, the extracted explicit feature may be mapped to a similar feature space with close data distribution and reduce the negative transfer phenomenon caused by joint training of data from different domains. In addition, in a case of the source domain and the target domain having an overlap, the data of the source domain is introduced into the training data of the ranking model in the form of implicit feature, so as to avoid the phenomenon of “negative transfer” caused by directly using the data of the source domain as training samples. The ranking model is trained based on the explicit feature and the implicit feature, which enriches the feature information of training samples, and may improve the recommendation effect of ranking model applied to resource recommendations.

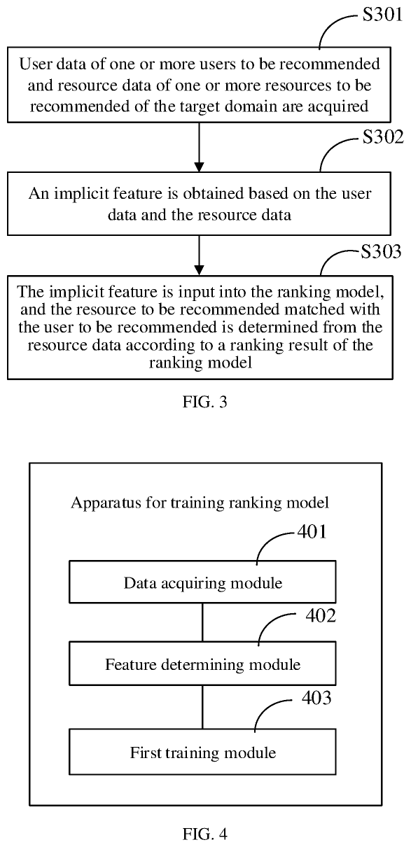

The embodiments of the present disclosure provide a resource recommendation method. FIG. 3 is a flowchart of a resource recommendation method in an embodiment of the present disclosure. The method may be applied to a resource recommendation apparatus. For example, when the apparatus is deployed on a terminal or a server or other processing equipment for execution, the apparatus may perform the training of the ranking model and the like. The terminal may be user equipment (UE, User Equipment), mobile device, cellular phone, cordless phone, personal digital assistant (PDA, Personal Digital Assistant), handheld device, computing device, vehicle-mounted device, wearable device, and the like. In some possible implementations, the method may also be implemented in a manner in which the processor invokes computer-readable instructions stored in the memory. As shown in FIG. 3, the intelligent recommendation methods may include the following steps.

In step S301, user data of one or more users to be recommended and resource data of one or more resources to be recommended of the target domain are acquired.

In step S302, an implicit feature is obtained based on the user data and the resource data.

The implicit user feature and implicit resource feature respectively corresponding to the user data and the resource data are extracted respectively through collaborative filtering and GNN, and then are concatenated according to the first concatenating manner to obtain the implicit feature.

In step S303, the implicit feature is input into the ranking model, and the resource to be recommended matched with the user to be recommended is determined from the resource data according to a ranking result of the ranking model.

The ranking model is obtained by training according to the training method of any embodiment of the present disclosure. The ranking result may be the probability corresponding to the matching degree between each user to be recommended and each resource to be recommended, or whether each user to be recommended matches with each resource to be recommended.

In the embodiments of the present disclosure, resource recommendation is performed on the user to be recommended according to the ranking result of the ranking model. The ranking model is obtained by training based on the implicit feature of the target domain data and the source domain data. Using the ranking model for resource recommendation may improve the recommendation effect.

FIG. 4 is a schematic diagram of an apparatus for training a ranking model in an embodiment of the present disclosure. As shown in FIG. 4, the apparatus for training a ranking model may include:
a data acquiring module 401 configured to acquire first user data and first resource data of a target domain, and acquiring second user data and second resource data of a source domain;
a feature determining module 402 configured to determine an implicit feature based on the first user data, the first resource data, the second user data and the second resource data; and
a first training module 403 configured to train the ranking model based on the implicit feature, wherein the ranking model is configured to recommend a resource to a user of the target domain.

In a possible implementation, the apparatus further includes a second training module configured to:
determine an explicit feature based on the first user data and the first resource data; and
train the ranking model based on the explicit feature and the implicit feature.

In a possible implementation, the second training module, when determining an explicit feature according to the first user data and the first resource data, is configured to:
acquire a first explicit user feature from the first user data of each of a plurality of target domains using a same feature encoding manner, and acquiring a first explicit resource feature from the first resource data of each of the plurality of target domains using a same feature encoding manner, wherein formats of the first explicit user features of the plurality of target domains are identical to each other, and formats of the first explicit resource features of the plurality of target domains are identical to each other; and
concatenate, for each of the target domains, the first explicit user feature and the first explicit resource feature in a first concatenating manner, to obtain the explicit feature.

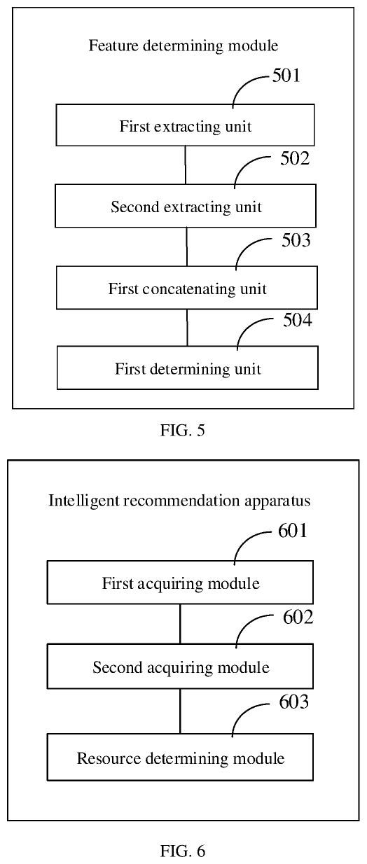

FIG. 5 is a schematic diagram of a feature determining module in an embodiment of the present disclosure. As shown in FIG. 5, in a possible implementation, the feature determining module includes a first extracting unit 501, a second extracting unit 502, a first concatenating unit 503 and a first determining unit 504.

The first extracting unit 501 is configured to extract a first implicit user feature from the first user data using a collaborative filtering manner, in a case of determining that the target domain and the source domain have an overlapping user according to the first user data and the second user data.

The second extracting unit 502 is configured to extract a second implicit user feature from the second user data of the overlapping user using the collaborative filtering manner.

The first concatenating unit 503 is configured to concatenate the first implicit user feature and the second implicit user feature in a second concatenating manner to obtain a concatenating user feature.

The first determining unit 504 is configured to determine the implicit feature based on the concatenating user feature.

In a possible implementation, the first concatenating unit 503 is configured to:
determine a first weight corresponding to the second implicit user feature based on a number of the second user data of the overlapping user and a number of the first user data; and
obtain the concatenating user feature based on the first implicit user feature, the second implicit user feature and the first weight.

In a possible implementation, the feature determining module 402 includes a third extracting unit, a fourth extracting unit, a second concatenating unit and a second determining unit.

The third extracting unit is configured to extract a first implicit resource feature from the first resource data using a collaborative filtering manner, in a case of determining that the target domain and the source domain have an overlapping resource according to the first resource data and the second resource data.

The fourth extracting unit is configured to extract a second implicit resource feature from the second resource data of the overlapping resource using the collaborative filtering manner.

The second concatenating unit is configured to concatenate the first implicit resource feature and the second implicit resource feature in a second concatenating manner to obtain a concatenating resource feature.

The second determining unit is configured to determine the implicit feature based on the concatenating resource feature.

In a possible implementation, the second concatenating unit is configured to:
determine a second weight corresponding to the second implicit resource feature based on a number of the second resource data of the overlapping resource and a number of the first resource data; and
obtain the concatenating resource feature based on the first implicit resource feature, the second implicit resource feature and the second weight.

In a possible implementation, the feature determining module 402 is specifically configured to:
extract a first joint implicit feature from the first user data and the first resource data using a graph neural network, in a case of determining that the target domain and the source domain have an overlapping user according to the first user data and the second user data;
extract a second joint implicit feature using the graph neural network based on the first resource data and second user data of the overlapping user; and
determine the implicit feature based on the first joint implicit feature and the second joint implicit feature.

In a possible implementation, the feature determining module 402 is specifically configured to:
extract a first joint implicit feature from the first user data and the first resource data using a graph neural network, in a case of determining that the target domain and the source domain have an overlapping resource according to the first resource data and the second resource data;
extract a third joint implicit feature using the graph neural network based on the first user data and second resource data of the overlapping resource; and
determine the implicit feature based on the first joint implicit feature and the third joint implicit feature.

In a possible implementation, the apparatus according further includes a feature determining configured to:
determine the implicit feature based on the first user data and the first resource data, in a case of determining that the target domain and the source domain have no overlapping user according to the first user data and the second user data and that the target domain and the source domain have no overlapping resource according to the first resource data and the second resource data.

In a possible implementation, the first training module 403 is specifically configured to:
concatenate the explicit feature and the implicit feature in a first concatenating manner to obtain a first concatenating feature, and acquiring a sample label corresponding to the first concatenating feature; and
train the ranking model based on the first concatenating feature and the corresponding sample label.

In a possible implementation, the apparatus further includes a recommending module configured to:
acquire user data of one or more users to be recommended and resource data of one or more resources to be recommended of the target domain;
obtain an implicit feature based on the user data and the resource data; and
input the implicit feature into the ranking model, and determine the resource to be recommended matched with the user to be recommended from the resource data according to a ranking result of the ranking model.

FIG. 6 is a schematic diagram of an intelligent recommendation apparatus in an embodiment of the present disclosure. As shown in FIG. 6, the intelligent recommendation apparatus includes:
a first acquiring module 601 configured to acquire user data of one or more users to be recommended and resource data of one or more resources to be recommended of a target domain;
a second acquiring module 602 configured to obtain an implicit feature based on the user data and the resource data; and
a resource determining module 603 configured to input the implicit feature into a ranking model, and determine the resource to be recommended matched with the user to be recommended from the resource data according to a ranking result of the ranking model,
the ranking model is obtained by training according to the method for training a ranking model of any one of the embodiments of the present disclosure.

For functions of each unit, module, or sub-module in each apparatus in the embodiments of the present disclosure, reference may be made to the corresponding descriptions in the above method embodiments, and details are not repeated here.

Acquiring, storing, and applying of the relevant data involved in the present disclosure comply with the provisions of relevant laws and regulations, and do not violate public order and good customs.

According to another aspect of the present disclosure, an electronic device is provided, including: at least one processor; and a memory communicatively connected with the at least one processor; wherein the memory stores instructions executable by the at least one processor, and the instructions, when executed by the at least one processor, cause the at least one processor to perform the method of any one of the embodiments of the present disclosure.

According to another aspect of the present disclosure, a non-transitory computer-readable storage medium storing computer instructions is provided, wherein the computer instructions are configured to cause the computer to perform the method of any one of the embodiments of the present disclosure.

According to another aspect of the present disclosure, a computer program product including a computer program is provided, wherein the computer program, when executed by a processor, implements the method of any one of the embodiments of the present disclosure.

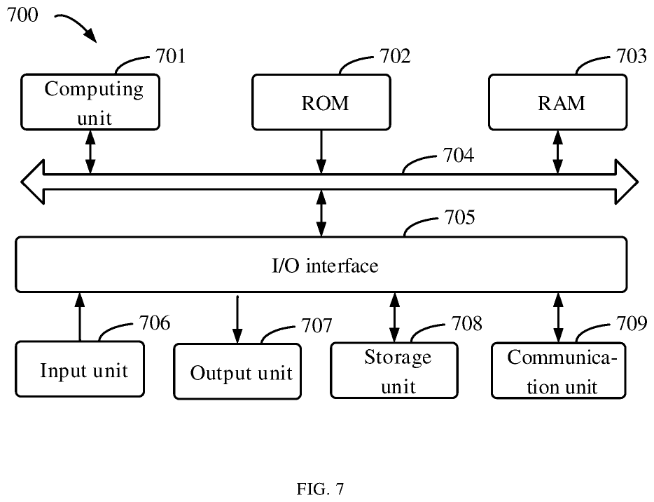

FIG. 7 shows a schematic block diagram of an example electronic device 700 used to implement the embodiments of the present disclosure. The electronic device is intended to represent various forms of digital computers, such as laptop computers, desktop computers, workstations, personal digital assistants, servers, blade servers, mainframe computers and other suitable computers. The electronic device may also represent various forms of mobile devices, such as personal digital processing, cellular phones, smart phones, wearable devices and other similar computing devices. The components shown herein, their connections and relationships, and their functions are merely examples, and are not intended to limit the implementation of the present disclosure described and/or required herein.

As shown in FIG. 7, the device 700 includes a computing unit 701, which may execute various appropriate actions and processing according to a computer program stored in a read only memory (ROM) 702 or a computer program loaded from a storage unit 708 into a random access memory (RAM) 703. Various programs and data required for the operation of the device 700 may also be stored in the RAM 703. The computing unit 701, the ROM 702 and the RAM 703 are connected to each other through a bus 704. An input/output (I/O) interface 705 is also connected to the bus 704.

The I/O interface 705 is connected to a plurality of components of the device 700, including: an input unit 706, such as a keyboard, a mouse, etc.; an output unit 707, such as various types of displays, speakers, etc.; a storage unit 708, such as a magnetic disk, an optical disk, etc.; and a communication unit 709, such as a network card, a modem, a wireless communication transceiver, etc. The communication unit 709 allows the device 700 to exchange information/data with other devices through the computer network such as the Internet and/or various telecommunication networks.

The computing unit 701 may be various general-purpose and/or special-purpose processing components with processing and computing capabilities. Some examples of computing unit 701 include, but are not limited to, central processing unit (CPU), graphics processing unit (GPU), various dedicated artificial intelligence (AI) computing chips, various processors that run machine learning model algorithms, digital signal processing DSP and any appropriate processor, controller, microcontroller, etc. The computing unit 701 executes the various methods and processes described above, such as the method for training a ranking model and the intelligent recommendation method. For example, in some embodiments, the method for training a ranking model and the intelligent recommendation method may be implemented as computer software programs, which are tangibly contained in the machine-readable medium, such as the storage unit 708. In some embodiments, part or all of the computer program may be loaded and/or installed on the device 700 via the ROM 702 and/or the communication unit 709. When the computer program is loaded into the RAM 703 and executed by the computing unit 701, one or more steps of the method for training a ranking model and the intelligent recommendation method described above may be executed. Alternatively, in other embodiments, the computing unit 701 may be configured to execute the method for controlling a terminal in any other suitable manner (for example, by means of firmware).

Various implementations of the systems and technologies described in the present disclosure may be implemented in digital electronic circuit systems, integrated circuit systems, field programmable gate arrays (FPGA), application specific integrated circuits (ASIC), application-specific standard products (ASSP), system-on-chip SOC, load programmable logic device (CPLD), computer hardware, firmware, software and/or their combination. The various implementations may include: being implemented in one or more computer programs, the one or more computer programs may be executed and/or interpreted on a programmable system including at least one programmable processor, the programmable processor may be a dedicated or general programmable processor. The programmable processor may receive data and instructions from a storage system, at least one input device and at least one output device, and the programmable processor transmit data and instructions to the storage system, the at least one input device and the at least one output device.

The program code used to implement the method of the present disclosure may be written in any combination of one or more programming languages. The program codes may be provided to the processors or controllers of general-purpose computers, special-purpose computers or other programmable data processing devices, so that the program code enables the functions/operations specific in the flowcharts and/or block diagrams to be implemented when the program code executed by a processor or controller. The program code may be executed entirely on the machine, partly executed on the machine, partly executed on the machine and partly executed on the remote machine as an independent software package, or entirely executed on the remote machine or server.

In the context of the present disclosure, the machine-readable medium may be a tangible medium, which may contain or store a program for use by the instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage media would include electrical connections based on one or more wires, portable computer disks, hard disks, random access memory (RAM), read only memory (ROM), erasable programmable read only memory (EPROM or flash memory), optical fiber, portable compact disk read only memory (CD-ROM), optical storage device, magnetic storage device or any suitable combination of the above-mentioned content.

In order to provide interaction with users, the systems and techniques described here may be implemented on a computer, the computer includes: a display device (for example, a CRT (cathode ray tube) or LCD (liquid crystal display) monitor) for displaying information to the user; and a keyboard and a pointing device (for example, a mouse or trackball). The user may provide input to the computer through the keyboard and the pointing device. Other types of devices may also be used to provide interaction with users. For example, the feedback provided to the user may be any form of sensory feedback (for example, visual feedback, auditory feedback or tactile feedback); and any form (including sound input, voice input, or tactile input) may be used to receive input from the user.

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation of the system and technology described herein), or in a computing system including any combination of such back-end components, middleware components or front-end components. The components of the system may be connected to each other through any form or medium of digital data communication (for example, a communication network). Examples of communication networks include: local area network (LAN), wide area network (WAN) and the Internet.

A computer system may include a client and a server. The client and the server are generally far away from each other and usually interact through the communication network. The relationship between the client and the server is generated by computer programs that run on the respective computers and have a client-server relationship with each other. The server may be a cloud server, a distributed system server, or a server combined with a blockchain.

It should be understood that the various forms of processes shown above may be used to reorder, add or delete steps. For example, the steps described in the present disclosure may be executed in parallel, sequentially or in a different order, as long as the desired result of the present disclosure may be achieved, which is not limited herein.

The above-mentioned specific implementations do not constitute a limitation on the protection scope of the present disclosure. Those skilled in the art should understand that various modifications, combinations, sub-combinations and substitutions may be made according to design requirements and other factors. Any modification, equivalent replacement and improvement made within the spirit and principle of the present disclosure shall be included in the protection scope of the present disclosure.

1. A method for training a ranking model, the method comprising:
acquiring first user data and first resource data of a target domain, and acquiring second user data and second resource data of a source domain;
determining an implicit feature based on the first user data, the first resource data, the second user data and the second resource data; and
training the ranking model based on the implicit feature, wherein the ranking model is configured to recommend a resource to a user of the target domain.

2. The method according to claim 1, further comprising:
determining an explicit feature based on the first user data and the first resource data; and
training the ranking model based on the explicit feature and the implicit feature.

3. The method according to claim 2, wherein the determining an explicit feature based on the first user data and the first resource data comprises:
acquiring a first explicit user feature from the first user data of each of a plurality of target domains using a same feature encoding manner, and acquiring a first explicit resource feature from the first resource data of each of the plurality of target domains using a same feature encoding manner, wherein formats of the first explicit user features of the plurality of target domains are identical to each other, and formats of the first explicit resource features of the plurality of target domains are identical to each other; and
concatenating, for each of the plurality of target domains, the first explicit user feature and the first explicit resource feature in a first concatenating manner, to obtain the explicit feature.

4. The method according to claim 1, wherein the determining an implicit feature based on the first user data, the first resource data, the second user data and the second resource data comprises:
extracting a first implicit user feature from the first user data using a collaborative filtering manner, in a case of determining that the target domain and the source domain have an overlapping user according to the first user data and the second user data;
extracting a second implicit user feature from the second user data of the overlapping user using the collaborative filtering manner;
concatenating the first implicit user feature and the second implicit user feature in a second concatenating manner to obtain a concatenating user feature; and
determining the implicit feature based on the concatenating user feature.

5. The method according to claim 4, wherein the concatenating the first implicit user feature and the second implicit user feature in a second concatenating manner to obtain a concatenating user feature comprises:
determining a first weight corresponding to the second implicit user feature based on a number of the second user data of the overlapping user and a number of the first user data; and
obtaining the concatenating user feature based on the first implicit user feature, the second implicit user feature and the first weight.

6. The method according to claim 1, wherein the determining an implicit feature based on the first user data, the first resource data, the second user data and the second resource data comprises:
extracting a first implicit resource feature from the first resource data using a collaborative filtering manner, in a case of determining that the target domain and the source domain have an overlapping resource according to the first resource data and the second resource data;
extracting a second implicit resource feature from the second resource data of the overlapping resource using the collaborative filtering manner;
concatenating the first implicit resource feature and the second implicit resource feature in a second concatenating manner to obtain a concatenating resource feature; and
determining the implicit feature based on the concatenating resource feature.

7. The method according to claim 6, wherein the concatenating the first implicit resource feature and the second implicit resource feature in a second concatenating manner to obtain a concatenating resource feature comprises:
determining a second weight corresponding to the second implicit resource feature based on a number of the second resource data of the overlapping resource and a number of the first resource data; and
obtaining the concatenating resource feature based on the first implicit resource feature, the second implicit resource feature and the second weight.

8. The method according to claim 1, wherein the determining an implicit feature based on the first user data, the first resource data, the second user data and the second resource data comprises:
extracting a first joint implicit feature from the first user data and the first resource data using a graph neural network, in a case of determining that the target domain and the source domain have an overlapping user according to the first user data and the second user data;
extracting a second joint implicit feature using the graph neural network based on the first resource data and second user data of the overlapping user; and
determining the implicit feature based on the first joint implicit feature and the second joint implicit feature.

9. The method according to claim 1, wherein the determining an implicit feature based on the first user data, the first resource data, the second user data and the second resource data comprises:
extracting a first joint implicit feature from the first user data and the first resource data using a graph neural network, in a case of determining that the target domain and the source domain have an overlapping resource according to the first resource data and the second resource data;
extracting a third joint implicit feature using the graph neural network based on the first user data and second resource data of the overlapping resource; and
determining the implicit feature based on the first joint implicit feature and the third joint implicit feature.

10. The method according to claim 1, further comprising determining the implicit feature based on the first user data and the first resource data, in a case of determining that the target domain and the source domain have no overlapping user according to the first user data and the second user data and that the target domain and the source domain have no overlapping resource according to the first resource data and the second resource data.

11. The method according to claim 2, wherein the training the ranking model based on the explicit feature and the implicit feature comprises:
concatenating the explicit feature and the implicit feature in a first concatenating manner to obtain a first concatenating feature, and acquiring a sample label corresponding to the first concatenating feature; and
training the ranking model based on the first concatenating feature and the corresponding sample label.

12. The method according to claim 1, further comprising:
acquiring user data of one or more users to be recommended and resource data of one or more resources to be recommended of the target domain;
obtaining an implicit feature based on the user data and the resource data; and
inputting the implicit feature into the ranking model, and determining the resource to be recommended matched with the user to be recommended from the resource data according to a ranking result of the ranking model.

13. An intelligent recommendation method, comprising:
acquiring user data of one or more users to be recommended and resource data of one or more resources to be recommended of a target domain;
obtaining an implicit feature based on the user data and the resource data; and
inputting the implicit feature into a ranking model, and determining the resource to be recommended matched with the user to be recommended from the resource data according to a ranking result of the ranking model,
wherein the ranking model is obtained by training according to the method for training a ranking model of claim 1.

14.-26. (canceled)

27. An electronic device, comprising:
at least one processor; and
a memory communicatively connected with the at least one processor;
wherein the memory stores instructions executable by the at least one processor, and the instructions, when executed by the at least one processor, cause the at least one processor to at least:
acquire first user data and first resource data of a target domain, and acquire second user data and second resource data of a source domain;
determine an implicit feature based on the first user data, the first resource data, the second user data and the second resource data; and
train the ranking model based on the implicit feature, wherein the ranking model is configured to recommend a resource to a user of the target domain.

28. A non-transitory computer-readable storage medium storing computer instructions, wherein the computer instructions are configured to cause a computer system to at least:
acquire first user data and first resource data of a target domain, and acquire second user data and second resource data of a source domain;
determine an implicit feature based on the first user data, the first resource data, the second user data and the second resource data; and
train the ranking model based on the implicit feature, wherein the ranking model is configured to recommend a resource to a user of the target domain.

29. (canceled)

30. The electronic device according to claim 27, wherein the instructions are further configured to cause the at least one processor to:
determine an explicit feature based on the first user data and the first resource data; and
train the ranking model based on the explicit feature and the implicit feature.

31. The electronic device according to claim 30, wherein the instructions are further configured to cause the at least one processor to, when determining the explicit feature based on the first user data and the first resource data:
acquire a first explicit user feature from the first user data of each of a plurality of target domains using a same feature encoding manner, and acquire a first explicit resource feature from the first resource data of each of the plurality of target domains using a same feature encoding manner, wherein formats of the first explicit user features of the plurality of target domains are identical to each other, and formats of the first explicit resource features of the plurality of target domains are identical to each other; and
concatenate, for each of the plurality of target domains, the first explicit user feature and the first explicit resource feature in a first concatenating manner, to obtain the explicit feature.

32. The electronic device according to claim 27, wherein the instructions are further configured to cause the at least one processor to, when determining the implicit feature based on the first user data, the first resource data, the second user data and the second resource data:
extract a first implicit user feature from the first user data using a collaborative filtering manner, in a case of determining that the target domain and the source domain have an overlapping user according to the first user data and the second user data;
extract a second implicit user feature from the second user data of the overlapping user using the collaborative filtering manner;
concatenate the first implicit user feature and the second implicit user feature in a second concatenating manner to obtain a concatenating user feature; and
determine the implicit feature based on the concatenating user feature.

33. An electronic device, comprising:
at least one processor; and
a memory communicatively connected with the at least one processor, wherein the memory stores instructions executable by the at least one processor, and the instructions, when executed by the at least one processor, cause the at least one processor to at least:
acquire user data of one or more users to be recommended and resource data of one or more resources to be recommended of a target domain;
obtain an implicit feature based on the user data and the resource data; and
input the implicit feature into a ranking model, and determine the resource to be recommended matched with the user to be recommended from the resource data according to a ranking result of the ranking model,
wherein the ranking model is obtained by training using the electronic device of claim 27.

34. A non-transitory computer-readable storage medium storing computer instructions, wherein the computer instructions are configured to cause a computer system to at least:
acquire user data of one or more users to be recommended and resource data of one or more resources to be recommended of a target domain;
obtain an implicit feature based on the user data and the resource data; and
input the implicit feature into a ranking model, and determine the resource to be recommended matched with the user to be recommended from the resource data according to a ranking result of the ranking model,
wherein the ranking model is obtained by training using the non-transitory computer-readable storage medium of claim 28.
